(19) United States
(12) Patent Application Publication
(10) Pub. No.: US 2025/0188787 A1
(43) Pub. Date: Jun. 12, 2025

(54) VEHICLE DOOR ASSEMBLY AND VEHICLE COMPRISING SAME

(71) Applicants: ZHEJIANG ZEEKR INTELLIGENT TECHNOLOGY CO., LTD., Ningbo (CN); ZHEJIANG GEELY HOLDING GROUP CO., LTD., Hangzhou (CN)

(72) Inventors: Xianjing FENG, Ningbo (CN); Te YIN, Ningbo (CN); Dehui WU, Ningbo (CN); Xiaoyuan JIANG, Ningbo (CN); Dacheng YANG, Ningbo (CN)

(21) Appl. No.: 19/058,048

(22) Filed: Feb. 20, 2025

Related U.S. Application Data
(63) Continuation of application No. PCT/CN2023/092296, filed on May 5, 2023.

(30) Foreign Application Priority Data
Aug. 23, 2022 (CN) 202211036597.6

(51) Int. Cl. E05F 15/63

(52) U.S. Cl. CPC E05F 15/63; E05Y 2900/531

(57) ABSTRACT

Provided are a vehicle door assembly and a vehicle including same. The vehicle door assembly includes a connection base, a first vehicle door, and a first drive mechanism connected to the first vehicle door. The first drive mechanism includes: a first link having two ends rotatably connected to the first vehicle door and the first connection portion, respectively; a second link having an end rotatably connected to the second connection portion; a third link having an end rotatably connected to the first vehicle door and another end rotatably connected to another end of the second link; and a first driver connected to the first link and configured to drive the first link to rotate relative to the first connection portion.

### CROSS-REFERENCE TO RELATED APPLICATION

This application is a continuation of International Application No. PCT/CN2023/092296, filed on May 5, 2023, which claims priority to Chinese Patent Application No. 202211036597.6 filed on Aug. 23, 2022, the entire contents of which are incorporated herein by reference.

### FIELD

The present disclosure relates to the field of vehicle technologies, and more particularly, to a vehicle door assembly and a vehicle including same.

### BACKGROUND

In the related art, doors of some vehicle models swing open. However, due to structural problems, front and rear doors of these vehicle models need to be opened in a predetermined order and cannot be opened independently as desired.

### SUMMARY

The present disclosure aims to solve at least one of the technical problems in the related art. To this end, the present disclosure aims to provide a vehicle door assembly. The vehicle door assembly can prevent a first vehicle door from interfering with other components during opening or closing of the first vehicle door, which ensures that the first vehicle door can be independently opened or closed without being restricted by other structures.

The present disclosure further provides a vehicle including the above vehicle door assembly.

In a first aspect of the present disclosure, a vehicle door assembly includes a connection base, a first vehicle door and a first drive mechanism. The connection base is provided with a first connection portion and a second connection portion spaced apart from each other. The first drive mechanism is connected to the first vehicle door and configured to open or close the first vehicle door. The first drive mechanism includes: a first link having two ends rotatably connected to the first vehicle door and the first connection portion, respectively; a second link having an end rotatably connected to the second connection portion; a third link having an end rotatably connected to the first vehicle door and another end rotatably connected to another end of the second link; and a first driver connected to the first link and configured to drive the first link to rotate relative to the first connection portion.

With the vehicle door assembly of the present disclosure, a second movable arm of a four-bar linkage mechanism is formed by using the second link and the third link that are rotatable relative to each other. When the first vehicle door is opened or closed, the third link rotates relative to the second link, in such a manner that an end of the first vehicle door can deflect relative to another end of the first vehicle door. In this way, other components can be avoided conveniently, which prevents the first vehicle door from interfering with other components during opening or closing of the first vehicle door, ensuring that the first vehicle door can be independently opened or closed without being restricted by other structures.

According to some embodiments of the present disclosure, the first drive mechanism further includes a second driver connected to the other end of the third link and configured to drive the third link to rotate relative to the second link.

According to some embodiments of the present disclosure, the first drive mechanism further includes a fourth link having two ends connected to the end of the third link and the second driver, respectively.

According to some embodiments of the present disclosure, the first vehicle door is provided with a first fixing mount. The other end of the third link and an end of the fourth link are rotatably connected to the first fixing mount about one axis.

According to some embodiments of the present disclosure, the second driver is fixed to the second link and located at a side of the second link facing away from the first link.

According to some embodiments of the present disclosure, the first driver is a drive motor; and/or the second driver is an electric strut.

According to some embodiments of the present disclosure, the first vehicle door is movable between an open position and a closed position relative to the connection base. The second link and the third link are collinear when the first vehicle door is in the open position or the closed position. An angle between the second link and the third link gradually decreases and then gradually increases when the first vehicle door is moved from the closed position to the open position.

According to some embodiments of the present disclosure, the vehicle door assembly further includes a locking mechanism including a lock body disposed at the connection base and a lock catch disposed at the second link. The locking mechanism has a locked state in which the lock catch is locked to the lock body and an unlocked state in which the lock catch is separable from the lock body.

According to some embodiments of the present disclosure, the first link is provided with a limit block at an end of the first link connected to the connection base. The limit block is located at a side of the first link facing away from the second link. The limit block is adapted to abut with a vehicle body of a vehicle when the first vehicle door is opened.

According to some embodiments of the present disclosure, the first link and the second link are spaced apart from each other in a horizontal direction. At least part of the first link in a length direction of the first link extends along an arc protruding towards the second link.

According to some embodiments of the present disclosure, the vehicle door assembly further includes: a second vehicle door arranged side by side with the first vehicle door; and a second drive mechanism connected to the second vehicle door and configured to open or close the second vehicle door. When both the first vehicle door and the second vehicle door are closed, a side edge of the first vehicle door facing towards the second vehicle door is located at an inner side of a side edge of the second vehicle door facing towards the first vehicle door.

In a second aspect of the present disclosure, a vehicle includes a vehicle body and the vehicle door assembly in the first aspect of the present disclosure. The connection base is fixed to the vehicle body.

With the vehicle according to the present disclosure, through disposing the vehicle door assembly in the above first aspect, the second movable arm of the four-bar linkage mechanism is formed by using the second link and the third link that are rotatable relative to each other. When the first vehicle door is opened or closed, the third link rotates relative to the second link, in such a manner that the end of the first vehicle door can deflect relative to the other end of the first vehicle door. In this way, other components can be avoided conveniently, which prevents the first vehicle door from interfering with other components during opening or closing of the first vehicle door, ensuring that the first vehicle door can be independently opened or closed without being restricted by other structures. Therefore, overall performance of the vehicle is enhanced.

Additional aspects and advantages of the present disclosure will be provided at least in part in the following description, or will become apparent at least in part from the following description, or can be learned from practicing of the present disclosure.

### BRIEF DESCRIPTION OF THE DRAWINGS

FIG. 1 is a schematic view of a vehicle door assembly according to an embodiment of the present disclosure, in which a door is in an open position.

FIG. 2 is an enlarged partial view of the vehicle door assembly in FIG. 1.

FIG. 3 is a schematic view of a vehicle door assembly according to an embodiment of the present disclosure, in which a door is in a closed position.

FIG. 4 is a schematic view of a vehicle door assembly according to an embodiment of the present disclosure, in which a door is in a position between an open position and a closed position.

FIG. 5 is a schematic view of the vehicle door assembly in FIG. 4, viewed from another perspective.

FIG. 6 is a schematic view of the vehicle door assembly in FIG. 4, viewed from yet another perspective.

FIG. 7 is a schematic view of a lock body in FIG. 6.

Reference numerals of the accompanying drawings:
100, vehicle door assembly;
10, connection base;
20, first vehicle door; 21, first fixing mount; 22, second fixing mount;
30, first drive mechanism;
31, first link; 311, limit block; 32, second link; 33, third link; 34, fourth link;
35, first driver; 36, second driver;
40, locking mechanism; 41, lock body; 42, lock catch.

### DETAILED DESCRIPTION

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limit, the present disclosure.

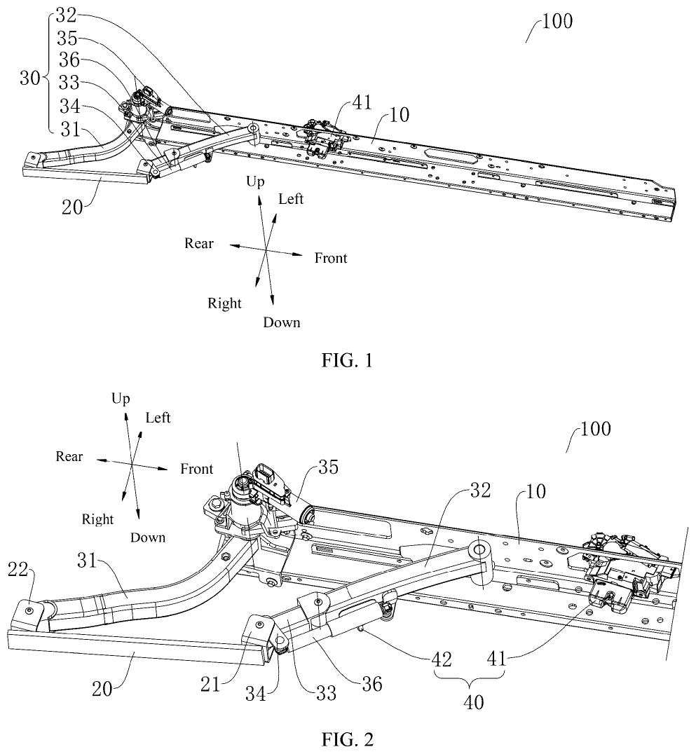

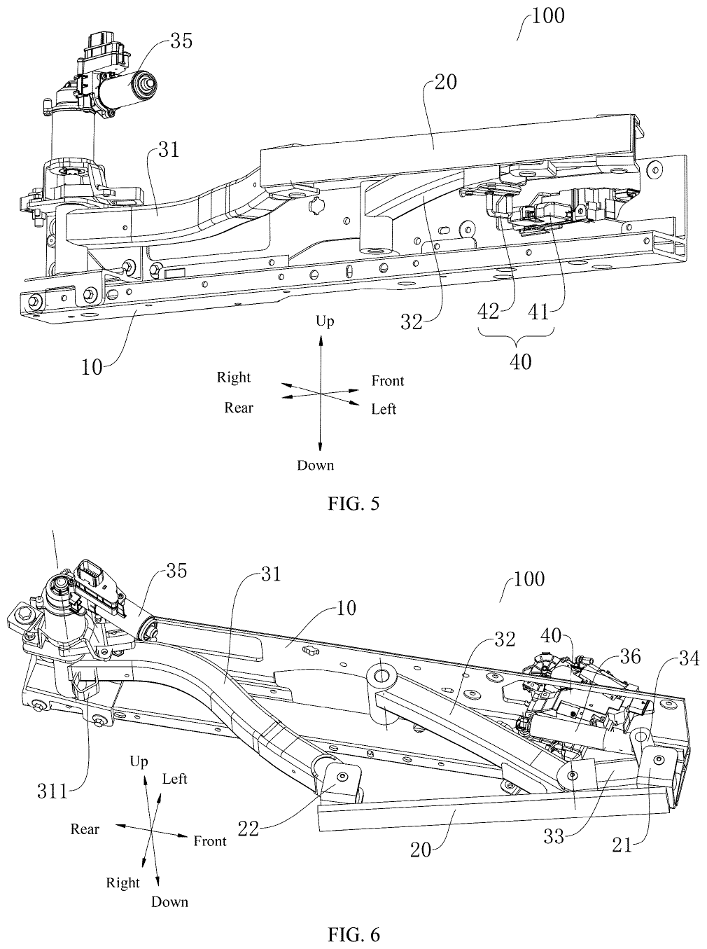

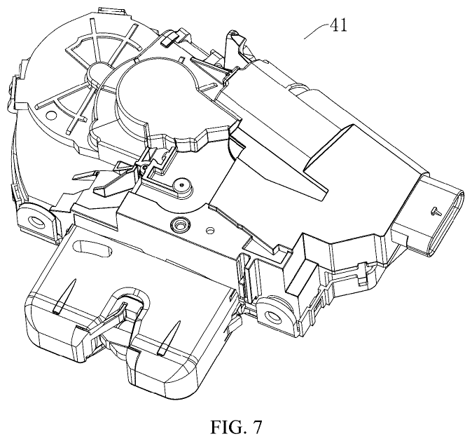

A vehicle door assembly 100 according to embodiments in a first aspect of the present disclosure is described below with reference to FIG. 1 to FIG. 7.

As illustrated in FIG. 1, the vehicle door assembly 100 according to the embodiments in the first aspect of the present disclosure includes a connection base 10, a first vehicle door 20, and a first drive mechanism 30. The first drive mechanism 30 is connected between the connection base 10 and the first vehicle door 20 and configured to drive the first vehicle door 20 to be opened or closed.

In an exemplary embodiment of the present disclosure, the connection base 10 is provided with a first connection portion and a second connection portion spaced apart from each other. For example, the first connection portion is spaced apart from the second connection portion in a front-rear direction.

The first drive mechanism 30 is connected to the first vehicle door 20 and configured to open or close the first vehicle door 20. The first drive mechanism 30 includes a first link 31, a second link 32, a third link 33, and a first driver 35. The first link 31 has two ends rotatably connected to the first vehicle door 20 and the first connection portion, respectively. The second link 32 has an end rotatably connected to the second connection portion. The third link 33 has an end rotatably connected to the first vehicle door 20 and another end rotatably connected to another end of the second link 32. The first driver 35 is connected to the first link 31 and configured to drive the first link 31 to rotate relative to the first connection portion.

For example, as illustrated in FIG. 2, the first link 31 has a left end rotatably connected to the first connection portion of the connection base 10 and a right end rotatably connected to the first vehicle door 20. The second link 32 has a left end rotatably connected to the second connection portion of the connection base 10 and a right end rotatably connected to a left end of the third link 33. The third link 33 has a right end rotatably connected to the first vehicle door 20.

In this case, the connection base 10, the first link 31, the second link 32, the third link 33, and the first vehicle door 20 form a four-bar linkage mechanism. The first link 31 is a first movable arm of the four-bar linkage mechanism. The second link 32 and the third link 33 together form a second movable arm of the four-bar linkage mechanism. When the first vehicle door 20 needs to be opened or closed, the first driver 35 is activated to drive the first link 31 to rotate around the first connection portion, and the first link 31 drives a second vehicle door, the second link 32, and the third link 33 to move, realizing opening or closing of the first vehicle door 20.

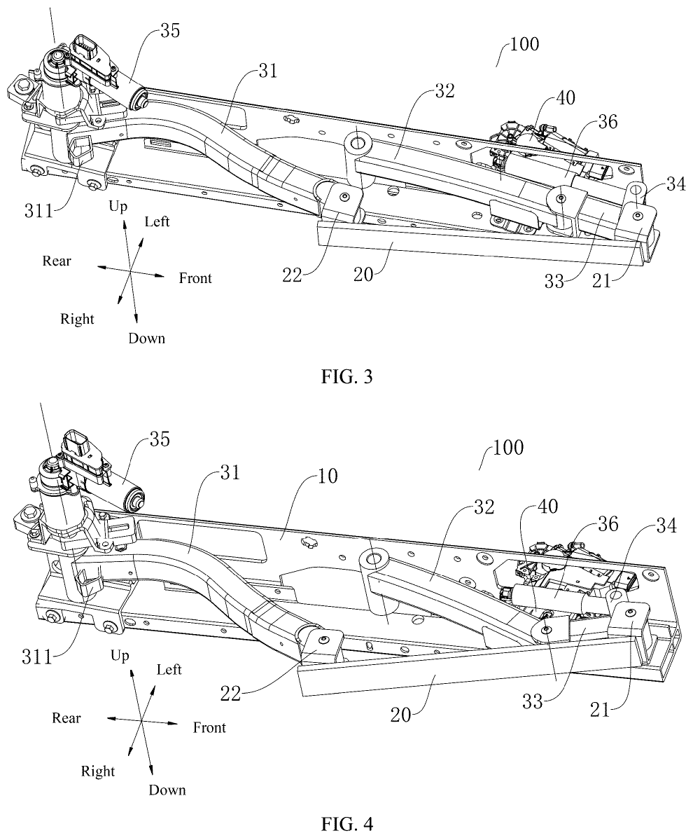

Since the second movable arm of the four-bar linkage mechanism is formed by the second link 32 and the third link 33 that are rotatable relative to each other, in a process of opening or closing the first vehicle door 20, a straight length of the second movable arm connected between the first vehicle door 20 and the connection base 10 can be reduced when the third link 33 rotates relative to the second link 32. Also, since a length of the first movable arm remains unchanged, an end of the first vehicle door 20 connected to the third link 33 (for example, a front end of the first vehicle door 20 illustrated in FIG. 3) is inclined and deflected towards the connection base 10 relative to another end of the first vehicle door 20 connected to the first link 31 (for example, a rear end of the first vehicle door 20 illustrated in FIG. 3). In this way, compared with a four-bar linkage mechanism in the related art, the four-bar linkage mechanism according to this embodiment enables a movement track of the first vehicle door 20 to be changed to deflect the end of the first vehicle door 20, which can facilitate the first vehicle door 20 in avoiding other components. Therefore, the first vehicle door 20 is prevented from interfering with other components during opening or closing of the first vehicle door 20, ensuring that the first vehicle door 20 can be independently opened or closed without being restricted by other structures.

With the vehicle door assembly 100 according to the embodiments of the present disclosure, the second movable arm of the four-bar linkage mechanism is formed by the second link 32 and the third link 33 that are rotatable relative to each other. When the first vehicle door 20 is opened or closed, the third link 33 rotates relative to the second link 32, in such a manner that the end of the first vehicle door 20 can deflect relative to the other end of the first vehicle door 20. In this way, other components can be avoided conveniently, which prevents the first vehicle door 20 from interfering with other components during opening or closing of the first vehicle door 20, ensuring that the first vehicle door 20 can be independently opened or closed without being restricted by other structures.

In some embodiments of the present disclosure, as illustrated in FIG. 3, FIG. 4, and FIG. 6, the first drive mechanism 30 may further include a second driver 36 connected to the other end of the third link 33 (for example, a front end of the third link 33 illustrated in FIG. 6) and configured to drive the third link 33 to rotate relative to the second link 32. In this embodiment, since the second driver 36 is provided, a length of the second movable arm may be controlled by controlling a rotation angle at which the second driver 36 drives the third link 33 to rotate relative to the second link 32. In this way, a deflection angle of the first vehicle door 20 is controlled to control the movement track of the first vehicle door 20. Therefore, other components can be avoided reasonably and efficiently to prevent the first vehicle door 20 from interfering with other components, ensuring that the first vehicle door 20 can be independently opened or closed.

In a specific embodiment of the present disclosure, as illustrated in FIG. 6, the first drive mechanism 30 may further include a fourth link 34. The fourth link 34 has two ends connected to the end of the third link 33 and the second driver 36, respectively. For example, as illustrated in FIG. 6, the fourth link 34 has a left end connected to the second driver 36 and a right end connected to the front end of the third link 33. The second driver 36 may drive the fourth link 34 to move, and then the end of the third link 33 is driven by the fourth link 34 to move, realizing a rotation of the third link 33 relative to the second link 32. Therefore, a structural layout is more compact and reasonable, which facilitates the second driver 36 in driving the third link 33 to rotate.

In a specific example of the present disclosure, as illustrated in FIG. 6, the first vehicle door 20 is provided with a first fixing mount 21. The other end of the third link 33 (for example, the front end of the third link 33 illustrated in FIG. 6) and an end of the fourth link 34 (for example, the right end of the fourth link 34 illustrated in FIG. 6) are rotatably connected to the first fixing mount 21 about one axis. Therefore, a connection structure among the third link 33, the fourth link 34, and the first vehicle door 20 can be simplified, which improves a manufacturing efficiency and an assembly efficiency.

As illustrated in FIG. 6, the protruding first fixing mount 21 is disposed at a side of the first vehicle door 20 facing towards the connection base 10. The first fixing mount 21 has a U-shaped structure opened towards the connection base 10. Each of the first fixing mount 21, the front end of the third link 33, and the right end of the fourth link 34 has a first through hole extending in an up-down direction. A first rotary shaft passes through the first through hole at each of the first fixing mount 21, the third link 33, and the fourth link 34, which enables the third link 33 and the fourth link 34 to be rotatably connected to the first vehicle door 20.

As illustrated in FIG. 6, the first vehicle door 20 is further provided with a second fixing mount 22 at the side of the first vehicle door 20 facing towards the connection base 10. The second fixing mount 22 also has a U-shaped structure opened towards the connection base 10. Each of the second fixing mount 22 and a front end of the first link 31 has a second through hole extending in the up-down direction. A second rotary shaft passes through the second through hole at each of the first link 31 and the second fixing mount 22, which enables the first link 31 to be rotatably connected to the first vehicle door 20.

In a specific embodiment of the present disclosure, as illustrated in FIG. 6, the second driver 36 is fixed to the second link 32 and located at a side of the second link 32 facing away from the first link 31 (for example, a front side of the second link 32 illustrated in FIG. 6). In this embodiment, directly fixing the second driver 36 to the second link 32 can facilitate the second driver 36 in directly driving the third link 33 to rotate relative to the second link 32, which realizes a simple structure and a reasonable layout. In addition, in this embodiment, by disposing the second driver 36 at the side of the second link 32 away from the first link 31, the second driver 36 can be prevented from occupying a space between the first link 31 and the second link 32. Therefore, the second driver 36 is prevented from interfering with movements of the first link 31, the second link 32, and the third link 33, which makes the layout reasonable and compact.

In a specific embodiment of the present disclosure, as illustrated in FIG. 6, the first driver 35 is a drive motor, which facilitates driving the first link 31 to rotate. In other embodiments, the first driver 35 may also be an electric strut, a hydraulic cylinder, etc.

In a specific embodiment of the present disclosure, as illustrated in FIG. 6, the second driver 36 is an electric strut, which can simplify a structure of the second driver 36 while realizing driving the third link 33 to rotate, reducing a space occupied. In other embodiments, the second driver 36 may also be a drive electrode, a hydraulic cylinder, etc.

In some embodiments of the present disclosure, as illustrated in FIG. 2 to FIG. 4, the first vehicle door 20 is movable between an open position (for example, a position of the first vehicle door 20 illustrated in FIG. 2) and a closed position (for example, a position of the first vehicle door 20 illustrated in FIG. 3) relative to the connection base 10. The second link 32 and the third link 33 are collinear when the first vehicle door 20 is in the open position. The second link 32 and the third link 33 are collinear when the first vehicle door 20 is in the closed position. An angle between the second link 32 and the third link 33 gradually decreases and then gradually increases when the first vehicle door 20 is moved from the closed position to the open position. In this way, it is convenient for the first vehicle door 20 to avoid other components, which further prevents the first vehicle door 20 from interfering with other components during opening or closing of the first vehicle door 20, ensuring that the first vehicle door 20 can be independently opened or closed without being restricted by other structures.

For example, as illustrated in FIG. 2 to FIG. 4, when the first vehicle door 20 is closed, the second link 32 and the third link 33 are collinear, in which case the angle between the second link 32 and the third link 33 is 180°. When the first vehicle door 20 needs to be opened, the first driver 35 drives the first link 31 to rotate while the third link 33 rotates relative to the second link 32. In this case, while the first vehicle door 20 moves backward as a whole, the front end of the first vehicle door 20 deflects leftwards in a counterclockwise direction, and the angle between the second link 32 and the third link 33 is less than 180°. In this way, not only can the components interfering with the front end of the first vehicle door 20 be avoided, but the first vehicle door 20 can also be opened backwards simultaneously. After the avoidance is completed, the first link 31 continues to rotate, and the third link 33 rotates relative to the second link 32, in such a manner that the third link 33 and the second link 32 return to an initial collinear position again, completely opening the first vehicle door 20.

In some embodiments of the present disclosure, the vehicle door assembly 100 may further include a locking mechanism 40 including a lock body 41 disposed at the connection base 10 and a lock catch 42 disposed at the second link 32. The locking mechanism 40 has a locked state in which the lock catch 42 is locked to the lock body 41 and an unlocked state in which the lock catch 42 is separable from the lock body 41. When the first vehicle door 20 is closed, the locking mechanism 40 is in the locked state. When the first vehicle door 20 needs to be opened, the locking mechanism 40 switches to the unlocked state. In this case, the first driver 35 can be activated to drive the first vehicle door 20 to open. In this embodiment, the lock catch 42 is disposed at the second link 32. When the first vehicle door 20 needs to be opened, the locking mechanism 40 switches to the unlocked state. In this case, the first driver 35 drives the first link 31 to move, which drives the second link 32 and the first vehicle door 20 to move. The lock catch 42 may be synchronously driven by the second link 32 to move, which enables the lock catch 42 to withdraw from the lock body 41, realizing a separation of the lock catch 42 from the lock body 41. When the first vehicle door 20 needs to be closed, the first driver 35 drives the first link 31 to move, which synchronously drives the first vehicle door 20 and the second link 32 to move, in such a manner that the lock catch 42 is re-brought into contact with the lock body 41 and locked to the lock body 41. In this case, the first vehicle door 20 is locked to the connection base 10.

In some embodiments of the present disclosure, as illustrated in FIG. 6, the first link 31 is provided with a limit block 311 at an end of the first link 31 connected to the connection base 10 (for example, a rear end of the first link 31 illustrated in FIG. 6). The limit block 311 is located at a side of the first link 31 facing away from the second link 32 (for example, a rear side of the first link 31 illustrated in FIG. 6). The limit block 311 is adapted to abut with a vehicle body of a vehicle when the first vehicle door 20 is opened. In this way, the limit block 311 can limit a rotational movement of the first link 31 to limit a position of the first link 31, ensuring that the first vehicle door 20 can accurately move to the open position.

In some embodiments of the present disclosure, as illustrated in FIG. 6, the first link 31 and the second link 32 are spaced apart from each other in a horizontal direction (for example, a front-rear direction illustrated in FIG. 6). At least part of the first link 31 in a length direction of the first link 31 extends along an arc protruding towards the second link 32. For example, the end of the first link 31 connected to the connection base 10 extends along an arc protruding forwards. Therefore, an opening degree of the first vehicle door 20 can be increased, which increases an efficiency of opening or closing the first vehicle door 20.

In some embodiments of the present disclosure, the first link 31 has an end rotatably disposed at the first connection portion of the connection base 10 about a first axis and another end rotatably connected to the first vehicle door 20 about a second axis. The second link 32 has an end rotatably connected to the second connection portion of the connection base 10 about a third axis and another end rotatably connected to the third link 33 about a fourth axis. Each of the third link 33 and the fourth link 34 has an end rotatably connected to the first vehicle door 20 about a fifth axis. The fourth link 34 has another end rotatably connected to an end of the second driver 36 about a sixth axis. The first axis, the second axis, the third axis, the fourth axis, the fifth axis, and the sixth axis are parallel to each other. In this way, the structure can be simplified to ensure smooth opening or closing of the first vehicle door 20.

In some embodiments of the present disclosure, the vehicle door assembly 100 may further include a second vehicle door and a second drive mechanism. The second vehicle door is arranged side by side with the first vehicle door 20. For example, the second vehicle door is arranged side by side with the first vehicle door 20 in a front-rear direction. The second drive mechanism is connected to the second vehicle door and configured to open or close the second vehicle door. In this embodiment, two doors (the first vehicle door 20 and the second vehicle door) are arranged side by side at a same access of the vehicle body. The first vehicle door 20 is configured to control exposure or coverage of a part of the access. The second vehicle door is configured to control exposure or coverage of another part of the access. In this embodiment, instead of being opened or closed simultaneously through linkage, the first vehicle door 20 and the second vehicle door are provided with the first drive mechanism 30 and the second drive mechanism which are independent of each other, respectively. Therefore, independent opening or closing of the first vehicle door 20 is realized through the first drive mechanism 30, and independent opening or closing of the second vehicle door is realized through the second drive mechanism. In this way, the first vehicle door 20 and the second vehicle door can be opened independently as desired, which realizes a simple structure, convenient control, high reliability, and low costs.

Further, when both the first vehicle door 20 and the second vehicle door are closed, a side edge of the first vehicle door 20 facing towards the second vehicle door is located at an inner side of a side edge of the second vehicle door facing towards the first vehicle door 20. For example, the first vehicle door 20 and the second vehicle door are arranged side by side in the front-rear direction, and the first vehicle door 20 is located at a rear side of the second vehicle door. When both the first vehicle door 20 and the second vehicle door are closed, a front side edge of the first vehicle door 20 is located at an inner side of a rear side edge of the second vehicle door. The inner side refers to a side of the second vehicle door facing towards an inside of the vehicle body. In this way, when the four-bar linkage mechanism in the related art is adopted for opening the first vehicle door 20, the first vehicle door 20 is unable to be opened due to an obstruction of the second vehicle door. Therefore, in the related art, the first vehicle door 20 and the second vehicle door need to be opened successively in linkage. However, in the first drive mechanism 30 in this embodiment, the second movable arm of the four-bar linkage mechanism is formed by using the second link 32 and the third link 33 that rotate relative to each other. When the first vehicle door 20 is opened or closed, the third link 33 rotates relative to the second link 32, in such a manner that the end of the first vehicle door 20 can deflect relative to the other end of the first vehicle door 20. Therefore, the second vehicle door can be avoided to prevent the first vehicle door 20 from interfering with the second vehicle door during opening or closing of the first vehicle door 20, ensuring that the first vehicle door 20 can be independently opened or closed without being restricted by a structure of the second vehicle door.

A vehicle according to the embodiments in a second aspect of the present disclosure includes a vehicle body and the vehicle door assembly 100 according to the above embodiments in the first aspect of the present disclosure. The connection base 10 is fixed to the vehicle body.

Other components and operations of the vehicle according to the embodiments of the present disclosure are known to those skilled in the art, and thus will not be described in detail herein.

With the vehicle according to the present disclosure, through disposing the vehicle door assembly 100 according to the embodiments in the above first aspect, the second movable arm of the four-bar linkage mechanism is formed by using the second link 32 and the third link 33 that are rotatable relative to each other. When the first vehicle door 20 is opened or closed, the third link 33 rotates relative to the second link 32, in such a manner that the end of the first vehicle door 20 can deflect relative to the other end of the first vehicle door 20. In this way, other components can be avoided conveniently, which prevents the first vehicle door 20 from interfering with other components during opening or closing of the first vehicle door 20, ensuring that the first vehicle door 20 can be independently opened or closed without being restricted by other structures. Therefore, overall performance of the vehicle is enhanced.

The vehicle door assembly 100 according to a specific embodiment of the present disclosure will be described below with reference to FIG. 1 to FIG. 7.

As illustrated FIG. 1, the vehicle door assembly 100 includes the connection base 10, the first vehicle door 20, the second vehicle door, the first drive mechanism 30, and the second drive mechanism.

In an exemplary embodiment of the present disclosure, the connection base 10 is configured to be connected to the vehicle body of the vehicle. The first vehicle door 20 is connected to the connection base 10 through the first drive mechanism 30. The first drive mechanism 30 is configured to drive the first vehicle door 20 to realize opening or closing of the first vehicle door 20. The second vehicle door is connected to the connection base 10 through the second drive mechanism. The second drive mechanism is configured to drive the second vehicle door to realize opening or closing of the second vehicle door. The first vehicle door 20 and the second vehicle door are arranged side by side at a same access of the vehicle body.

The first drive mechanism 30 includes the first link 31, the second link 32, the third link 33, the first driver 35, and the second driver 36. The first link 31 has two ends hinged to the first vehicle door 20 and the connection base 10, respectively. The second link 32 is disposed at a front side of the first link 31 and has an end hinged to the connection base 10 and another end hinged to the third link 33. Another end of the third link 33 and an end of the fourth link 34 are coaxially hinged to the first vehicle door 20. The first driver 35 is disposed at the connection base 10. The first driver 35 is a drive motor. The first driver 35 is connected to the first link 31 and configured to drive the first link 31 to rotate. The second driver 36 is disposed at the second link 32. The second driver 36 is an electric strut. The second driver 36 has a drive end hinged to another end of the fourth link 34. The second link 32 is provided with the lock catch 42 at a lower side of the second link 32. The connection base 10 is provided with the lock body 41 configured to be in locking engagement with the lock catch 42 to lock the first vehicle door 20.

A structure of the second drive mechanism may be the same as that of the first drive mechanism 30. The second drive mechanism may also be a four-bar linkage mechanism in the related art.

The process of opening the first vehicle door 20 of the vehicle door assembly 100 according to the embodiments of the present disclosure is described below.

When the first vehicle door 20 needs to be opened, a drive motor (the first driver 35) drives a transmission member connected between the drive motor and the first link 31 to rotate about the first axis. The first link 31 rotates about the first axis and drives the first vehicle door 20 to move. The second link 32 rotates about the third axis. In addition, the electric strut (the second driver 36) is compressed, in such a manner that the third link 33 is driven by the fourth link 34 to rotate about the fourth axis. The second link 32 rotates about the third axis, enabling the lock catch 42 to be unlocked and separated from the lock body 41. Then, the drive motor continues to drive the first link 31 to rotate about the first axis. The first vehicle door 20 moves rearwards until the first vehicle door 20 is fully opened. In addition, the process of closing the first vehicle door 20 and a process of unlocking of the first vehicle door 20 are completely opposite to the above process of opening the first vehicle door 20, and thus details thereof will be omitted here.

The vehicle door assembly 100 according to the embodiments of the present disclosure can realize independent opening of any one of the first vehicle door 20 and the second vehicle door, in such a manner that a structure for opening the door is simple, with low costs and high reliability, realizing a lightweight design of the vehicle door assembly 100. In addition, when the first vehicle door 20 is opened or closed, the third link 33 rotates relative to the second link 32, in such a manner that the end of the first vehicle door 20 can deflect relative to the other end of the first vehicle door 20. Therefore, the second vehicle door can be avoided to prevent the first vehicle door 20 from interfering with the second vehicle door during opening or closing of the first vehicle door 20, ensuring that the first vehicle door 20 can be independently opened or closed without being restricted by the structure of the second vehicle door.

In the description of the present disclosure, it should be understood that the orientation or the position indicated by terms such as “center”, “longitudinal”, “transverse”, “length”, “width”, “thickness”, “over”, “below”, “front”, “rear”, “left”, “right”, “vertical”, “horizontal”, “top”, “bottom”, “inner”, “outer”, “clockwise”, “anti-clockwise”, “axial”, “radial”, and “circumferential” should be construed to refer to the orientation or the position as shown in the drawings, and is only for the convenience of describing the present disclosure and simplifying the description, rather than indicating or implying that the pointed device or element must have a specific orientation, or be constructed and operated in a specific orientation, and therefore cannot be understood as a limitation of the present disclosure.

In addition, the terms “first” and “second” are only used for descriptive purposes, and cannot be understood as indicating or implying relative importance or implicitly indicating the number of indicated technical features. Therefore, the features associated with “first” and “second” may explicitly or implicitly include at least one of the features. In the description of the present disclosure, “plurality” means at least two, unless otherwise specifically defined.

In the present disclosure, unless otherwise clearly specified and limited, terms such as “install”, “connect”, “connect to”, “fix”, and the like should be understood in a broad sense. For example, it may be a fixed connection or a detachable connection or connection as one piece; mechanical connection or electrical connection or communication; direct connection or indirect connection through an intermediate; internal communication of two components or the interaction relationship between two components. For those of ordinary skill in the art, the specific meaning of the above-mentioned terms in the present disclosure can be understood according to specific circumstances.

Reference throughout this specification to “an embodiment”, “some embodiments”, “an example”, “a specific example”, or “some examples” means that a particular feature, structure, material, or characteristic described in connection with the embodiment or example is included in at least one embodiment or example of the present disclosure. The appearances of the above phrases in various places throughout this specification are not necessarily referring to the same embodiment or example. Further, the particular features, structures, materials, or characteristics may be combined in any suitable manner in one or more embodiments or examples. In addition, different embodiments or examples and features of different embodiments or examples described in the specification may be combined by those skilled in the art without mutual contradiction.

Although embodiments of the present disclosure have been illustrated and described, it is conceivable for those of ordinary skill in the art that various changes, modifications, replacements, and variations can be made to these embodiments without departing from the principles and spirit of the present disclosure. The scope of the present disclosure shall be defined by the claims as appended and their equivalents.

What is claimed is:

1. A vehicle door assembly, comprising:
a connection base provided with a first connection portion and a second connection portion spaced apart from each other;
a first vehicle door; and
a first drive mechanism connected to the first vehicle door and configured to open or close the first vehicle door, the first drive mechanism comprising:
a first link having two ends rotatably connected to the first vehicle door and the first connection portion, respectively;
a second link having an end rotatably connected to the second connection portion;
a third link having an end rotatably connected to the first vehicle door and another end rotatably connected to another end of the second link; and
a first driver connected to the first link and configured to drive the first link to rotate relative to the first connection portion.

2. The vehicle door assembly according to claim 1, wherein the first drive mechanism further comprises a second driver connected to the other end of the third link and configured to drive the third link to rotate relative to the second link.

3. The vehicle door assembly according to claim 2, wherein the first drive mechanism further comprises a fourth link having two ends connected to the end of the third link and the second driver, respectively.

4. The vehicle door assembly according to claim 3, wherein the first vehicle door is provided with a first fixing mount, the other end of the third link and an end of the fourth link being rotatably connected to the first fixing mount about one axis.

5. The vehicle door assembly according to claim 2, wherein the second driver is fixed to the second link and located at a side of the second link facing away from the first link.

6. The vehicle door assembly according to claim 2, wherein:
the first driver is a drive motor; and/or
the second driver is an electric strut.

7. The vehicle door assembly according to claim 1, wherein the first vehicle door is movable between an open position and a closed position relative to the connection base, the second link and the third link being collinear when the first vehicle door is in the open position or the closed position, and an angle between the second link and the third link gradually decreasing and then gradually increasing when the first vehicle door is moved from the closed position to the open position.

8. The vehicle door assembly according to claim 1, further comprising a locking mechanism, the locking mechanism comprising a lock body disposed at the connection base and a lock catch disposed at the second link,
wherein the locking mechanism has a locked state in which the lock catch is locked to the lock body and an unlocked state in which the lock catch is separable from the lock body.

9. The vehicle door assembly according to claim 1, wherein the first link is provided with a limit block at an end of the first link connected to the connection base, the limit block being located at a side of the first link facing away from the second link, and the limit block being adapted to abut with a vehicle body of a vehicle when the first vehicle door is opened.

10. The vehicle door assembly according to claim 1, wherein the first link and the second link are spaced apart from each other in a horizontal direction, at least part of the first link in a length direction of the first link extending along an arc protruding towards the second link.

11. The vehicle door assembly according to claim 1, further comprising:
a second vehicle door arranged side by side with the first vehicle door; and
a second drive mechanism connected to the second vehicle door and configured to open or close the second vehicle door,
wherein when both the first vehicle door and the second vehicle door are closed, a side edge of the first vehicle door facing towards the second vehicle door is located at an inner side of a side edge of the second vehicle door facing towards the first vehicle door.

12. A vehicle, comprising:
a vehicle body; and
the vehicle door assembly according to claim 1, the connection base being fixed to the vehicle body.

13. The vehicle according to claim 12, wherein the first drive mechanism further comprises a second driver connected to the other end of the third link and configured to drive the third link to rotate relative to the second link.

14. The vehicle according to claim 13, wherein the first drive mechanism further comprises a fourth link having two ends connected to the end of the third link and the second driver, respectively.

15. The vehicle according to claim 14, wherein the first vehicle door is provided with a first fixing mount, the other end of the third link and an end of the fourth link being rotatably connected to the first fixing mount about one axis.

16. The vehicle according to claim 13, wherein the second driver is fixed to the second link and located at a side of the second link facing away from the first link.

17. The vehicle according to claim 13, wherein:
the first driver is a drive motor; and/or
the second driver is an electric strut.

18. The vehicle according to claim 12, wherein the first vehicle door is movable between an open position and a closed position relative to the connection base, the second link and the third link being collinear when the first vehicle door is in the open position or the closed position, and an angle between the second link and the third link gradually decreasing and then gradually increasing when the first vehicle door is moved from the closed position to the open position.

19. The vehicle according to claim 12, wherein the vehicle door assembly further comprises a locking mechanism, the locking mechanism comprising a lock body disposed at the connection base and a lock catch disposed at the second link,
wherein the locking mechanism has a locked state in which the lock catch is locked to the lock body and an unlocked state in which the lock catch is separable from the lock body.

20. The vehicle according to claim 12, wherein the first link is provided with a limit block at an end of the first link connected to the connection base, the limit block being located at a side of the first link facing away from the second link, and the limit block being adapted to abut with a vehicle body of a vehicle when the first vehicle door is opened.
